(19) United States
(12) Patent Application Publication
(10) Pub. No.: US 2026/0287814 A1
(43) Pub. Date: Sep. 24, 2026

(54) OPTICAL DEVICE, INTEGRATED OPTICAL DEVICE, AND METHOD OF MANUFACTURING OPTICAL DEVICE

(71) Applicant: TDK CORPORATION, Tokyo (JP)

(72) Inventors: Ryohei FUKUZAKI, Hong Kong (CN); Masahiro SHINKAI, Tokyo (JP); Takashi HONDA, Tokyo (JP)

(73) Assignee: TDK CORPORATION, Tokyo (JP)

(21) Appl. No.: 19/574,666

(22) Filed: Mar. 23, 2026

(30) Foreign Application Priority Data
Mar. 24, 2025 (JP) 2025-048025

(51) Int. Cl. G02B 6/122; G02B 6/12

(52) U.S. Cl. CPC G02B 6/122; G02B 2006/12104; G02B 2006/12121; G02B 2006/12123

(57) ABSTRACT

An optical device includes: a substrate; a waveguide layer that is provided on the substrate, and that includes an optical waveguide including an incident port on which light from outside becomes incident and an exit port from which the light emerges outside, the optical waveguide propagating the light from the incident port to the exit port; and a protection layer that is provided on the waveguide layer, in which, among peripheral surfaces of a stack of the substrate, the waveguide layer, and the protection layer, a first side surface having neither the incident port nor the exit port has a surface roughness greater than a second side surface having the incident port or the exit port.

### CROSS REFERENCE TO RELATED APPLICATION

This application claims the benefit of Japanese Priority Patent Application No. 2025-048025 filed on Mar. 24, 2025, the entire contents of which are incorporated herein by reference.

### FIELD

The present disclosure relates to an optical device, an integrated optical device, and a method of manufacturing the optical device.

### BACKGROUND

An optical device provided with an optical waveguide is used by being connected to an element such as a laser diode serving as a light source, an optical fiber propagating communication signals, another optical device, or the like. In such an optical device, stray light resultant of leakage from a waveguide layer may prohibit the optical device from achieving the intended function. In order to block such stray light resultant of leakage from the waveguide layer, devising for providing a wall-like or a columnar wiring electrode inside of the optical device is coming into practical use (for example, see Patent Publication JP-A-2020-205373).

However, given that embedding wiring electrodes for blocking stray light in an optical device is a complicated and costly process, there has been a need for simpler and more effective countermeasures for such stray light.

One aspect of the present disclosure has been made to address such a need, and an object of the present disclosure is to provide an optical device and the like that can reduce the effect of stray light on the optical output, using a simpler configuration.

### SUMMARY

An optical device according to a first aspect of the present disclosure includes: a substrate; a waveguide layer that is provided on the substrate, and that includes an optical waveguide including an incident port on which light from outside becomes incident and an exit port from which the light emerges outside, the optical waveguide propagating the light from the incident port to the exit port; and a protection layer that is provided on the waveguide layer, in which, among peripheral surfaces of a stack of the substrate, the waveguide layer, and the protection layer, a first side surface having neither the incident port nor the exit port has a surface roughness greater than a second side surface having the incident port or the exit port.

Further, an integrated optical device according to a second aspect of the present disclosure is an integrated optical device including: the optical device described above; a light source that generates the light; and a package including the optical device and the light source, in which the package has a light shielding member on a surface that faces the first side surface of the optical device.

According to the present disclosure, it is possible to provide an optical device and the like that can reduce the effect of stray light on the optical output, using a simpler configuration.

### BRIEF DESCRIPTION OF THE DRAWINGS

The accompanying drawings are included to provide a further understanding of the disclosure and are incorporated in and constitute a part of this specification. The drawings illustrate example embodiments and, together with the specification, serve to explain the principles of the technology.

FIG. 1 is a schematic diagram for explaining a configuration of a projector that uses a light source unit including an optical device according to an example embodiment;

FIGS. 2A and 2B are a plan view and a front view of the light source unit, respectively;

FIG. 3 is a flowchart illustrating a process of manufacturing the optical device;

FIG. 4 is a conceptual schematic diagram for explaining a dicing process;

FIG. 5 is a plan view of an optical device having been subjected to another type of smoothing;

FIG. 6 is a plan view of an optical device having been subjected to still another type of smoothing;

FIG. 7 is a plan view of the optical device after grooves are formed by additional processing; and

FIG. 8 is a plan view of an integrated optical device including an optical device enclosed in a package.

### DETAILED DESCRIPTION

In the following, some example embodiments and modification examples of the technology are described in detail with reference to the accompanying drawings. Note that the following description is directed to illustrative examples of the disclosure and not to be construed as limiting the technology. Factors including, without limitation, numerical values, shapes, materials, components, positions of the components, and how the components are coupled to each other are illustrative only and not to be construed as limiting the technology. Further, elements in the following example embodiments which are not recited in a most-generic independent claim of the disclosure are optional and may be provided on an as-needed basis. The drawings are schematic and are not intended to be drawn to scale. Like elements are denoted with the same reference numerals to avoid redundant descriptions.

An example embodiment of the present disclosure will now be described with reference to the accompanying drawings. Note that elements designated by same reference signs in the respective drawings share an identical or a similar configuration. The example embodiment is, however, not intended to limit the scope of the technology as defined in the appended aspects. Furthermore, all of the configurations described in the example embodiment are not necessarily essential as means for addressing the need.

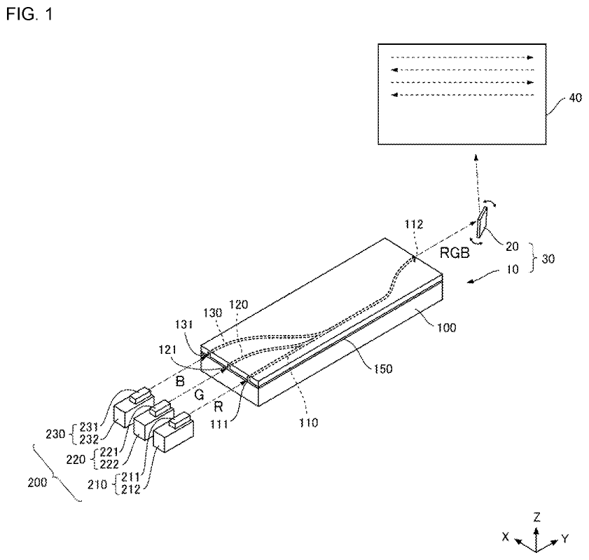

FIG. 1 is a schematic diagram for explaining a configuration of a projector 30 that uses a light source unit 10 including an optical device 100 according to one example embodiment. The projector 30 projects an image onto a screen 40, by causing a micro electromechanical systems (MEMS) mirror to scan a screen 40 with projection light output from the light source unit 10 while changing the direction of the projection light over time. The projector 30 is one aspect of an integrated optical device.

The light source unit 10 includes the optical device 100 and a light-emitting device 200. The light-emitting device 200 includes three light-emitting modules, namely, a red light-emitting module 210, a green light-emitting module 220, and a blue light-emitting module 230. These light-emitting modules are bonded to an end face of the optical device 100 and thus integrated as one unit, as will be described later, but in the drawing, the light-emitting modules are illustrated as separated from the end face of the optical device 100.

The optical device 100 has a shape of a rectangular parallelepiped as a whole. In the drawing, among the planar directions thereof, the short-hand direction is defined as an X-axis direction, and the longitudinal direction is defined as a Y-axis direction. The height direction orthogonal to the planar directions is defined as a Z-axis direction. Note that the subsequent drawings also include the same coordinate axes with respect to the orientation of the optical device 100 in FIG. 1 to indicate the orientations of the structures illustrated in the respective drawings.

The optical device 100 includes a waveguide layer 150 in a direction parallel with the XY plane. The waveguide layer 150 is formed of an electro-optical material such as a lithium niobate, and has ridges each having a projecting cross-section achieved by partially removing a part of the electro-optical material by etching or the like. Each of the ridges functions as an optical waveguide through which the light is passed, and in the example embodiment, three optical waveguides, namely, a first optical waveguide 110, a second optical waveguide 120, and a third optical waveguide 130, are formed on the waveguide layer. The waveguide layer 150 may also be formed of a PLC including a core forming the optical waveguides and a clad surrounding the core. The PLC is formed by a semiconductor process including photolithographic processing and dry etching.

The first optical waveguide 110 delineates a straight line or gently curved line that is continuous from a first incident end face 111 exposed to one side surface of the optical device 100, to an exit end face 112 exposed to the opposite one side surface of the optical device 100. In other words, the laser light becoming incident on the first incident end face 111 propagates through the first optical waveguide 110, and emerges out of the exit end face 112.

The second optical waveguide 120 delineates a straight line or gently curved line that is continuous from a second incident end face 121 that is exposed to the one side surface of the optical device 100, the one side surface being the surface provided with the first incident end face 111, to the point where second optical waveguide 120 merges the first optical waveguide 110, at an intermediate position of the first optical waveguide 110. In other words, the laser light becoming incident on the second incident end face 121 propagates through the second optical waveguide 120, merges the first optical waveguide 110 along the way, and emerges out of the exit end face 112.

The third optical waveguide 130 delineates a straight line or gently curved line that is continuous from a third incident end face 131 that is exposed to the one side surface of the optical device 100, the one side surface being the surface provided with the first incident end face 111, to the point where the third optical waveguide 130 merges the first optical waveguide 110, at an intermediate position of the first optical waveguide 110. In other words, the laser light becoming incident on the third incident end face 131 propagates through the third optical waveguide 130, merges the first optical waveguide 110 along the way, and emerges out of the exit end face 112.

Note that the configurations of these three optical waveguides are not limited to the example described above, and may be any configurations as long as each of the optical waveguides has an incident end face, and merges the other optical waveguides along the way leading to a common exit end face. The optical waveguide may be also branched again on the downstream side of the merging points between the three optical waveguides, to have two or more exit end faces.

The red light-emitting module 210 includes a red laser diode 211 and a first carrier 212 supporting the red laser diode 211. The red laser diode 211 is fixed to the first carrier 212. The red laser light emitted from the red laser diode 211 becomes incident on the first incident end face 111 of the first optical waveguide 110.

The green light-emitting module 220 includes a green laser diode 221 and a second carrier 222 supporting the green laser diode 221. The green laser diode 221 is fixed to the second carrier 222. The green laser light emitted from the green laser diode 221 becomes incident on the second incident end face 121 of the second optical waveguide 120.

The blue light-emitting module 230 includes a blue laser diode 231 and a third carrier 232 supporting the blue laser diode 231. The blue laser diode 231 is fixed to the third carrier 232. The blue laser light emitted from the blue laser diode 231 becomes incident on the third incident end face 131 of the third optical waveguide 130.

As described above, because the second optical waveguide 120 and the third optical waveguide 130 merge the first optical waveguide 110, when the light beams are output from a plurality of laser diodes simultaneously, mixed light resulting from these light beams is output from the exit end face 112. More specifically, by controlling the red laser diode 211, the green laser diode 221, and the blue laser diode 231 to emit light at their respective emission intensities, light of any color can be emitted from the exit end face 112.

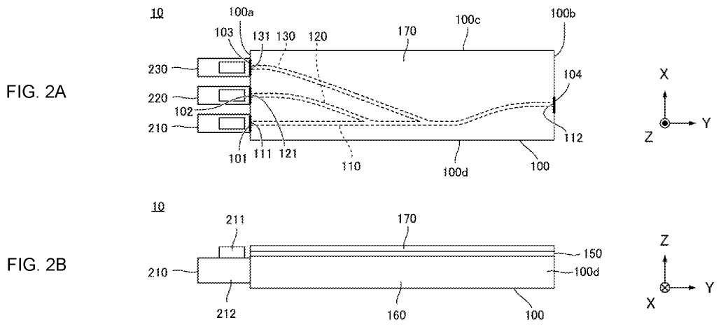

FIG. 2A is a plan view, and FIG. 2B is a front view of the light source unit 10. As illustrated in the front view, the optical device 100 includes a substrate 160 as a base layer, the waveguide layer 150 stacked on the substrate 160, and a protection layer 170 as a cover layer covering the waveguide layer. As the substrate 160, for example, an Si substrate or a sapphire substrate is used. As the protection layer 170, silicon dioxide (SiO₂) is used, for example. A material such as alumina (Al₂O₃) may also be used for the protection layer 170. In the example embodiment, the space formed as a result of removing the waveguide layer 150 by etching or the like, for the purpose of forming the optical waveguides, is filled with the protection layer 170. Furthermore, in the example embodiment, the substrate 160 is used as the base layer, and the protection layer 170 is used as the cover layer, but at least one of the substrate 160 or the protection layer 170 may be replaced with a cladding layer, or provided as well as with a cladding layer. The cladding layer is formed of a material having a lower refractive index than that of the waveguide layer 150, and yttrium oxide (Y₂O₃) is used, as an example.

Each of the light-emitting modules (the red light-emitting module 210, the green light-emitting module 220, and the blue light-emitting module 230) is integrated with the optical device 100, by having the carrier thereof (the first carrier 212, the second carrier 222, or the third carrier 232) bonded to the substrate 160. The optical device 100 may also have an anti-reflective film and a solder film applied to the one side surface where these light-emitting modules are to be bonded, and have an anti-reflective film applied to the opposite one side surface where the exit end face 112 is provided. Further, among the surfaces of each of the carriers, the surface to be bonded with the substrate 160 may be applied with Au coating.

The optical device 100, having an overall shape of a rectangular parallelepiped, has four peripheral surfaces (a first peripheral surface 100a, a second peripheral surface 100b, a third peripheral surface 100c, and a fourth peripheral surface 100d). The first peripheral surface 100a and the second peripheral surface 100b are peripheral surfaces that form the respective short sides of the rectangle in a plan view, and the third peripheral surface 100c and the fourth peripheral surface 100d are surfaces that form the respective long sides in a plan view, and are provided at positions connecting the first peripheral surface 100a and the second peripheral surface 100b. Among these peripheral surfaces, the first peripheral surface 100a includes the first incident end face 111, the second incident end face 121, and the third incident end face 131 that serve as incident ports on which the light beams from the respective light emitting modules become incident. The first peripheral surface 100a also has a first smoothed section 101, a second smoothed section 102, and a third smoothed section 103 that are sections including the respective incident end faces and having been subjected to smoothing by polishing. The second peripheral surface 100b includes the exit end face 112 serving as an exit port from which the light exits, and has a fourth smoothed section 104 that is the section including the exit end face 112 and having been subjected to smoothing by polishing, in the same manner as the first smoothed section 101, the second smoothed section 102, and the third smoothed section 103. The smoothing is adjusted such that each of these smoothed sections has an arithmetic average roughness (Ra) of less than 15 nm. Note that, in the example embodiment, from the viewpoint of keeping the smoothing simple, it is assumed that each of the smoothed sections extends, in the thickness direction (Z-axis direction), across the entire optical device 100 including the substrate 160 and the protection layer 170; however, the area of each of the smoothed sections may be limited locally to an area around the corresponding end face of the waveguide layer 150.

The third peripheral surface 100c and the fourth peripheral surface 100d including none of the incident end faces and the exit end face of the waveguide layer 150 are kept as the optical device 100 is diced from an array substrate, such as a wafer, without applying smoothing. The arithmetic average roughness (Ra) of the third peripheral surface 100c and the fourth peripheral surface 100d after such dicing is dependent on the dicing technique, but in the example embodiment, is adjusted to be not less than 0.4 μm and less than 1.5 μm. Further, because the other areas of the first peripheral surface 100a and the second peripheral surface 100b, other than the smoothed sections having been subjected to the smoothing, are also kept as diced, such areas have the same surface roughness as that of the third peripheral surface 100c and the fourth peripheral surface 100d. In other words, the side surfaces not including either the incident end faces or the exit end face (the third peripheral surface 100c and the fourth peripheral surface 100d in the example embodiment, and the first side surface as recited in the aspects) have a surface roughness greater than that of the side surfaces including the incident end faces or the exit face (the first peripheral surface 100a and the second peripheral surface 100b in the example embodiment, and the second side surface as recited in the aspects).

By applying the smoothing only to the sections including the laser-beam incident faces or exit end face in the manner described above, the surface roughness of the other peripheral surfaces remains as diced, so that most of the stray light resultant of leakage from the optical waveguide reaches these peripheral surfaces and scatters, so that it is possible to suppress an adverse effect in the output direction. That is, it is possible to reduce output of unexpected laser light toward the MEMS mirror 20.

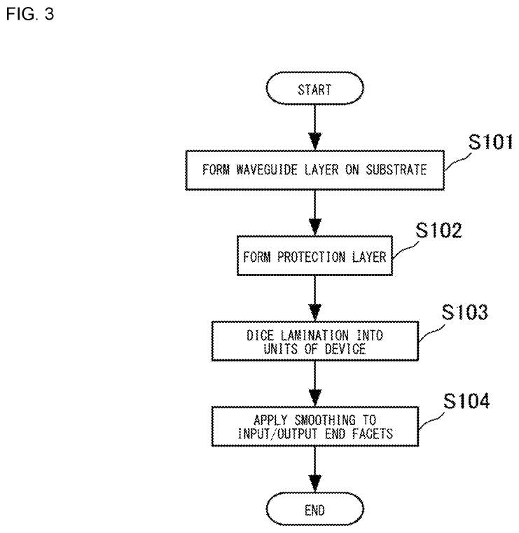

A manufacturing process of manufacturing the optical device 100 will now be described. FIG. 3 is a flowchart illustrating the process of manufacturing the optical device 100.

In step S101, an array substrate (e.g., an Si substrate or a sapphire substrate), such as a wafer on which a plurality of optical devices 100 can be arranged in the planar direction, is prepared. The waveguide layer is then formed by laminating an electro-optical material (e.g., lithium niobate) on the array substrate. The ridges, which will serve as the optical waveguides, corresponding to each optical device 100 are then formed by etching.

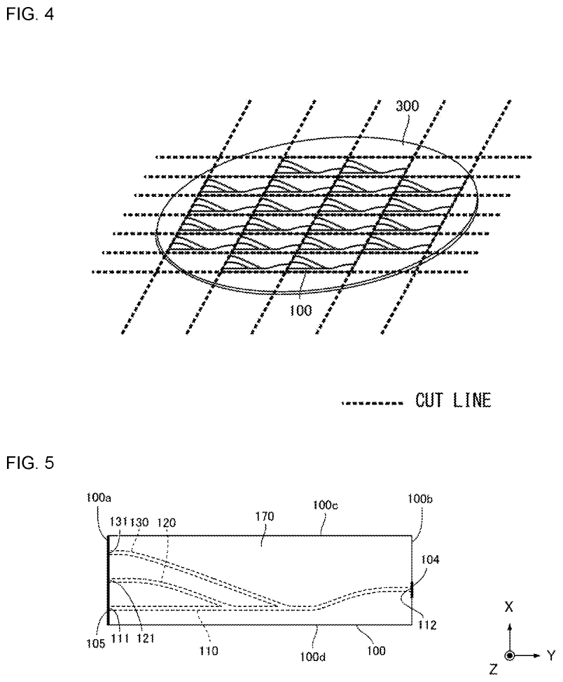

Next, in step S102, a material such as silicon dioxide is deposited so as to cover the waveguide layer, on which the ridges have been formed, to form the protection layer. In step S103, the lamination of the substrate, the waveguide layer, and the protection layer is then diced into pieces in the size of an optical device 100, using a cutter such as a dicer. FIG. 4 is a conceptual schematic illustrating the concept of the dicing process. As the blade of the cutter is scanned along cut lines, the individual optical devices 100 are separated. At this time, a dicing tape may be placed on the rear surface of the array substrate 300, or the periphery of the array substrate 300 may be fixed with a frame so that the individual optical devices 100 do not scatter as the array substrate 300 is cut.

Referring back to FIG. 3, the control is shifted to step S104. In step S104, the diced optical devices 100 are then subjected to smoothing by a polisher, so as to form the first smoothed section 101, the second smoothed section 102, the third smoothed section 103, and the fourth smoothed section 104, which correspond to the incident and exit end faces as described above. through the steps described above, individual optical devices 100 are manufactured.

Variations in the areas to be subjected to the smoothing will now be described. FIG. 5 is a plan view of an optical device 100 having been subjected to another type of smoothing. The optical device 100 illustrated in FIG. 5 is different from the optical device 100 illustrated in FIG. 2 in that the entire first peripheral surface 100a including the first incident end face 111, the second incident end face 121, and the third incident end face 131 is smoothed, as a fifth smoothed section. Such smoothing can be carried out for the entire first peripheral surface 100a, so that the processing is simplified. Further, because the roughness of the third peripheral surface 100c and the fourth peripheral surface 100d is maintained, in the same manner as in the optical device 100 illustrated in FIG. 2, it is possible to suppress stray light from reaching the second peripheral surface 100b where the exit end face 112 is provided.

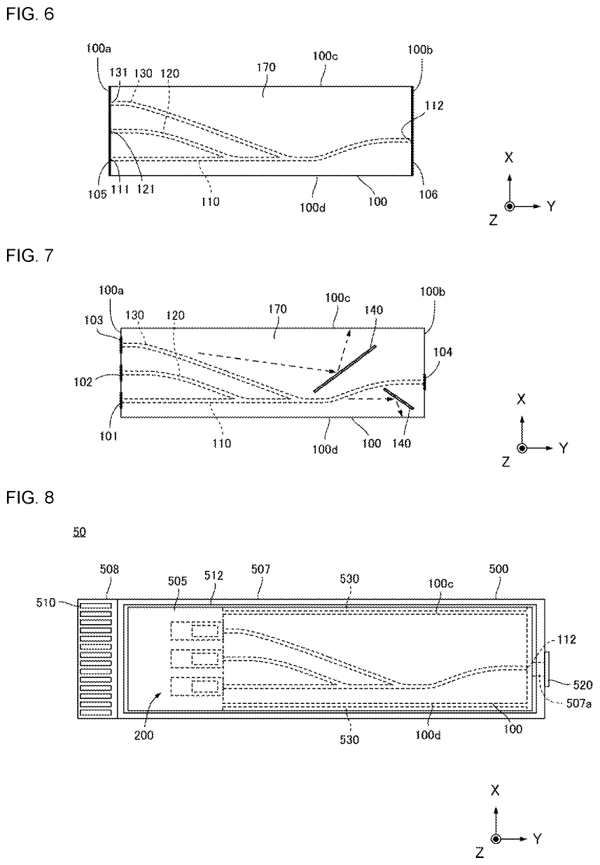

FIG. 6 is a plan view of an optical device 100 having been subjected to still another type of smoothing. The optical device 100 illustrated in FIG. 6 is different from the optical device 100 illustrated in FIG. 2 in that the entire first peripheral surface 100a is provided as the fifth smoothed section, in the same manner as the optical device 100 illustrated in FIG. 5, and that the entire second peripheral surface 100b including the exit end face 112 is also subjected to smoothing, as a sixth smoothed section. Because the entire second peripheral surface 100b as well as the entire first peripheral surface 100a can be subjected to the processing, such smoothing can be further simplified. Further, because the roughness of the third peripheral surface 100c and the fourth peripheral surface 100d is maintained, in the same manner as in the optical device 100 illustrated in FIG. 2, it is possible to suppress stray light from reaching the second peripheral surface 100b where the exit end face 112 is provided.

Additional processing that may be applied to the optical device 100 will now be described. FIG. 7 is a plan view of an optical device 100 after grooves 140 are formed by additional processing. The optical device 100 illustrated in FIG. 7 is different from the optical device 100 illustrated in FIG. 2 in that two grooves 140 are formed by additional processing.

The grooves 140 are provided at positions where the stray light resultant of the leakage from the waveguide are likely to reach, at angles allowing the stray light to become reflected toward the third peripheral surface 100c or the fourth peripheral surface 100d, and by a depth where the protection layer 170 and the waveguide layer 150 are cut thereby, for example. Because the roughness of the third peripheral surface 100c and the fourth peripheral surface 100d is maintained, the stray light reflected on the grooves 140 scatters on the third peripheral surface 100c or the fourth peripheral surface 100d.

Although such grooves 140 function as reflectors for reflecting the stray light, structures for reflecting the stray light toward the third peripheral surface 100c or the fourth peripheral surface 100d, or toward other sections of the peripheral surfaces not having been subjected to smoothing are not limited to grooves. For example, a material having a different refractive index may be provided to a part of the protection layer 170 so that stray light becomes reflected on the boundary between the materials.

An integrated optical device will now be described. FIG. 8 is a plan view of an integrated optical device 50. The optical device 100 and the light-emitting device 200 enclosed in a package 500 are indicated in the dotted lines. With the package 500 enclosing the optical device 100 and the light-emitting device 200, the optical device 100 and the light-emitting device 200 according to the example embodiment can form the integrated optical device 50.

The package 500 has a box-like housing 507 the top surface of which is open, and an electrode 508 adjacent to the housing 507. The package 500 is made of ceramics, for example.

A metal film 512 is formed around the peripheral edge of the opening of the housing 507 with the optical device 100 and the light-emitting device 200 enclosed therein. A cover 505 seals the box-shaped space of the housing 507 air-tightly, by coming into close contact with the metal film 512 without any gap. The air-tightly sealed box-shaped space is filled with an inert gas, for example.

The optical device 100 and the light-emitting device 200 are fixed to the bottom surface of the housing 507 with epoxy resin, for example. The housing 507 has a pass-through window 507a through which the light output from the exit end face 112 is passed, at a position facing the exit end face 112 of the optical device 100 fixed thereto. A glass plate 520 is then fixed with adhesive in a manner covering the pass-through window 507a from the outer side of the housing 507. Accordingly, the glass plate 520, too, serves to maintain the air-tightness of the box-shaped space of the housing 507. Anti-reflection films are formed on both surfaces of the glass plate 520, respectively.

The optical device 100 is adjusted such that the third peripheral surface 100c and the fourth peripheral surface 100d remain as rough surfaces, as described above. Therefore, in the example embodiment, light shielding members 530 are provided to the surfaces facing the third peripheral surface 100c and the fourth peripheral surface 100d, respectively. As the light shielding members 530, for example, light-shielding plates painted in black may be used. by providing the light shielding members 530 in the manner described above, it is possible to suppress the stray light having scattered on the third peripheral surface 100c and the fourth peripheral surface 100d from reflecting on the inner wall surfaces of the housing 507 and going back to the optical device 100. The light shielding members 530 may be provided to the inner wall surfaces of the housing 507 where the stray light having scattered on the rough surface can reach, without limitation to the positions described above, or may also be provided on the inner surface of the cover 505.

The electrode 508 is provided adjacently to a short-hand side of the housing 507 near the light-emitting device 200. A plurality of electrode pads 510 are provided on the top surface of the electrode 508, and each of the electrode pads 510 is electrically connected to one of the terminals of the light-emitting device 200.

1. An optical device comprising:
a substrate;
a waveguide layer that is provided on the substrate, and that includes an optical waveguide including an incident port on which light from outside becomes incident and an exit port from which the light emerges outside, the optical waveguide propagating the light from the incident port to the exit port; and
a protection layer that is provided on the waveguide layer, wherein
among peripheral surfaces of a stack of the substrate, the waveguide layer, and the protection layer, a first side surface having neither the incident port nor the exit port has a surface roughness greater than a second side surface having the incident port or the exit port.

2. The optical device according to claim 1, wherein the first side surface has a surface roughness greater than the surface roughness of entirety of the second side surface.

3. The optical device according to claim 1, wherein
the second side surface includes an input end face having the incident port, an output end face having the exit port, the input end face and the output end face are provided at positions facing each other on the peripheral surfaces, and
the first side surface is provided at a position connecting the input end face and the output end face.

4. The optical device according to claim 3, wherein the optical waveguide includes a plurality of incident ports and a single exit port.

5. The optical device according to claim 1, further comprising a reflector that reflects stray light, which is leaked from the optical waveguide to the protection layer, toward the first side surface.

6. An integrated optical device comprising:
the optical device according to claim 1;
a light source that generates the light; and
a package including the optical device and the light source, wherein
the package has a light shielding member on a surface that faces the first side surface of the optical device.

7. An integrated optical device comprising:
the optical device according to claim 2;
a light source that generates the light; and
a package including the optical device and the light source, wherein
the package has a light shielding member on a surface that faces the first side surface of the optical device.

8. An integrated optical device comprising:
the optical device according to claim 3;
a light source that generates the light; and
a package including the optical device and the light source, wherein
the package has a light shielding member on a surface that faces the first side surface of the optical device.

9. An integrated optical device comprising:
the optical device according to claim 4;
a light source that generates the light; and
a package including the optical device and the light source, wherein
the package has a light shielding member on a surface that faces the first side surface of the optical device.

10. An integrated optical device comprising:
the optical device according to claim 5;
a light source that generates the light; and
a package including the optical device and the light source, wherein
the package has a light shielding member on a surface that faces the first side surface of the optical device.
